(19) United States
(12) Patent Application Publication
(10) Pub. No.: US 2025/0347235 A1
(43) Pub. Date: Nov. 13, 2025

(54) Green Hydrogen for the Generation of Electricity and Other Uses

(71) Applicant: Alfred Sklar, Miami, FL (US)

(72) Inventor: Alfred Sklar, Miami, FL (US)

(21) Appl. No.: 18/867,149

(22) PCT Filed: May 17, 2023
(86) PCT No.: PCT/US2023/022510

§ 371 Date: Nov. 19, 2024

Related U.S. Application Data
(60) Provisional application No. 63/344,061, filed on May 20, 2022.

(51) Int. Cl. F01K 17/06; C25B 1/04; F01K 17/04; F01K 23/06; F01K 23/10

(52) U.S. Cl. CPC F01K 17/06; C25B 1/04; F01K 17/04; F01K 23/064; F01K 23/10

(57) ABSTRACT

The disclosure provides systems and′methods for generating electricity, while using a portion of the generated electricity and/or thermal energy (heat) for producing green hydrogen through the electrolysis of water. Using this protocol, a first round of electricity can be generated at a combustion device, i.e., a combustion turbine unit, and the excess thermal energy (heat) generated can be used to generate a second round of electricity, in order to evacuate any contaminating gases from either the first round or the second round of electrical power generation, the contaminating gases are made to flow through a chimney stack and dispersed into the environment.

### FIELD OF THE INVENTION

The disclosure generally relates to the generation of electricity, and more particularly to a system and method for generating electricity, while producing green hydrogen through the electrolysis of water, and storing and/or using the generated green hydrogen as a fuel source for further generation of electricity or other industrial processes.

### BACKGROUND OF THE INVENTION

Electricity is not freely available in nature to end users, so it must be generated or produced by transforming other forms of energy into electricity for its delivery, transmission, and distribution to end users. The generation of electricity is carried out in power plants most often by electro-mechanical generators primarily driven by heat engines fueled by combustion of hydrocarbon fuels such as coal and natural gas, or by other means such as the kinetic energy of flowing water and wind. Other energy sources include solar photovoltaic cells, geothermal power and hydrogen gas. Most of the world's electricity generation, at this time, comes from coal (37%) and natural gas (24%).

Much of the hydrogen generated in the world today comes from the process of steam methane reforming (SMR). In this process, methane (CH₄) or natural gas (that is predominantly methane) is reacted with water and a catalyst with heat to generate hydrogen (H₂) and carbon dioxide (CO₂) as shown via equations 1 and 2:

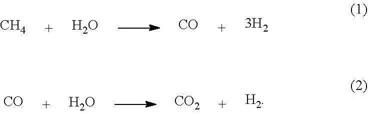

Based on these equations, for each mole of methane and two moles of water used, one mole of carbon dioxide and four moles of hydrogen are produced. Putting this into perspective of the volumes required for power generation, a single General Electric 6B.03 gas) turbine operating 8,000 hours per year would consume approximately 33 million kilograms of hydrogen per year. If the hydrogen was generated via SMR, this would produce 178,000 metric tons of carbon dioxide per year. Since the purpose of the transition from consuming hydrocarbons to hydrogen is to avoid releasing carbon dioxide into the atmosphere, it would seem counterproductive to release similar volumes of carbon dioxide in the process of generating the hydrogen intended to reduce the carbon footprint being released to ambient via subsequent combustion.

One of the proposals intended to justify the production of hydrogen via hydrocarbon reforming is that the carbon compounds released during the, say, blue hydrogen manufacturing, can be captured and stored. There have been various historical efforts intended to capture harmful materials and store them indefinitely. A notable example is the experience with storing spent uranium from nuclear power plants on the seafloor or in deep caverns. Radioactive materials have recognized lifetimes for their radioactive decay. Carbon dioxide does not and it will persist on geologic time scales. Methane was captured in the polar ice sheets and in Greenland, only to be released once again into the atmosphere as the ice melts. This is an important contributor to and consequence of global warming. To rely on carbon capture and storage, even if plausible over short term periods of time, can be viewed as postponing, and even worsening, the environmental carbon crisis rather than providing a solution to the problem of global warming induced by increasing levels of carbon dioxide in our atmosphere.

Gases that trap heat in the atmosphere are called greenhouse gases and are thought to capture heat in the environment, stimulate global atmospheric warming, and be a major cause of climate change. The primary greenhouse gases in our atmosphere are carbon dioxide (CO₂), methane (CH₄), nitrous oxide (N₂O), and to a lesser extent ammonia (NH₃). Most greenhouse gases have a variable residence time in our atmosphere and their lifetimes cannot be specified precisely. During the process of photosynthesis, vegetation consumes carbon dioxide, water, and solar energy to produce oxygen and sugars. More than half of carbon dioxide emitted is removed from the atmosphere within a century, but about 20% of emitted carbon dioxide remains in the atmosphere for many thousands to hundreds of thousands of years.

Given the widespread use of coal, natural gas and other hydrocarbons to generate electricity and the ongoing climate situation, there remains a need in the art for improved systems and methods for generating electricity from hydrocarbon fuels while minimizing the amount of greenhouse gases like carbon dioxide being produced, but an even greater need to find a means for transition from consuming hydrocarbons providing electricity and other forms of energy to providing electricity from renewable sources. One of the recognized hurdles for this transition to become widespread is the levelized cost of production per kilogram of green hydrogen. This is one of the subject matters of the present invention.

### SUMMARY OF THE INVENTION

The disclosure provides systems and methods for generating electricity, while using a portion of the generated electricity and/or thermal energy (heat) for producing green hydrogen through the electrolysis of water. Using this protocol, a first round of electricity can be generated at a combustion device, i.e., a combustion turbine unit, and the excess thermal energy (heat) generated can be used to generate a second round of electricity. In order to evacuate any contaminating gases from either the first round or the second round of electrical power generation, the contaminating gases are made to flow through a chimney stack and dispersed into the environment. To avoid the cost of pumping the contaminating gases, sufficient heat is supplied to the contaminating gases to ensure the thermodynamic balance required for effective dispersal into the environment. At each step, a portion of each round of generated electricity and/or thermal energy (heat) can be used in the electrolysis of water to generate green hydrogen, which can be stored and/or used as a fuel source for further generation of electricity. Using the present invention, the discarded waste heat can be used effectively to lower the cost of producing hydrogen.

The disclosure also provides systems and methods for generating electricity related to any industrial activity that requires a fuel to provide energy, for example a furnace. The energy source for the system and method for utilizing industrial equipment can be partially or wholly replaced by consuming the required energy source, while producing green energy through the electrolysis of water, and storing and/or using the generated green hydrogen as a fuel source for further operation of the industrial activity.

The disclosure further provides systems and methods for generating green hydrogen fuel that can be produced almost anywhere on Earth where there is an abundant supply of water. Since hydrogen is difficult to transport in its liquid state because of the low temperatures required, confinement of the hydrogen molecule is difficult to warrant. The disclosure further suggests that the transportation industry not rely on vehicle, aircraft, or ocean vessels consuming hydrogen, but rather to rely on electrical resupply over power transmission lines that recharge electrical storage batteries in the respective vehicles, aircraft, or ocean vessels.

The disclosure further provides systems and methods for generating green hydrogen fuel at a sufficiently competitive price to render the manufacture of BioFuels that consume green hydrogen in the production of Sustainable Aviation Fuels (“SAF”), biodiesel, and other biofuels where such biofuels can supply in whole or in part the fuel needs of vehicles, aircraft, or ocean vessels where the recharge of remote electrical storage batteries is difficult to accomplish.

Further features and advantages of the disclosure, as well as the structure and operation of various embodiments of the disclosure, are described in detail below concerning the accompanying drawings.

### BRIEF DESCRIPTION OF THE DRAWINGS

The disclosure, by one or more various embodiments, is described in detail concerning the following figures. The drawings are provided for the purposes of illustration only and merely depict exemplary embodiments of the disclosure. These drawings are provided to facilitate the reader's understanding of the disclosure and should not be considered limiting the breadth, scope, or applicability of the disclosure. It should be noted that for clarity and ease of illustration these drawings are not necessarily made to scale.

FIG. 1 illustrates an embodiment of a system for generating electricity, while producing green hydrogen through the electrolysis of water, and storing and/or using the generated green hydrogen as a fuel source for further generation of electricity; and

FIG. 2 illustrates how VM/VT (fuel cost reduction factor) varies for M (number stages)=5, 6, 7, 8, 9, 10 for different values of electrolyzer efficiency.

### DETAILED DESCRIPTION OF THE EMBODIMENTS

The following description is presented to enable a person of ordinary skill in the art to make and use embodiments described herein. Descriptions of specific devices, techniques. and applications are provided only as examples. Various modifications to the examples described herein will be readily apparent to those of ordinary skill in the art, and the general principles defined herein may be applied to other examples and applications without departing from the spirit and scope of the disclosure. Thus, the disclosure is not intended to be limited to the examples described herein and shown but is to be accorded the scope consistent with the claims.

The word “exemplary” is used herein to mean “serving as an example illustration,” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein reference numerals refer to like elements throughout.

It should be understood that the specific order or hierarchy of steps in the process disclosed herein is an example of exemplary approaches. Based upon design preferences, it is understood that the specific order or hierarchy of steps in the processes can be rearranged while remaining within the scope of the disclosure. Any accompanying method claims present elements of the various steps in a sample order, and are not meant to be limited to the specific order or hierarchy presented.

Considerable strides have been accomplished in generating hydroelectric energy, as well as eolic (wind) and photovoltaic (solar) energy. Although green hydrogen is widely heralded as the replacement for hydrocarbon fuels, the cost of producing hydrogen remains today as economically not viable when compared to the cost of consuming hydrocarbons. No suitable system and method of producing electricity to produce and/or consume green hydrogen has emerged. This is the subject matter of the present disclosure.

The electrolysis of water is an established method of producing both hydrogen and oxygen. The method varies from one extreme where the entire amount of energy to drive the electrolysis process is provided by electrical energy. At the other extreme, the electrolysis is driven by heat that in turn raises the temperature of the water in the electrolysis cell to over 2200° C., causing the water molecule to dissociate naturally, and hence requiring a minimal current to draw the dissociated components towards the respective electrodes. The present disclosure aims to use excess waste heat in power generation to heat the water entering the electrolysis cells and reduce the amount of electrical energy needed to complete the green electrolysis process.

At present, there are different types of electrolyzers depending on their size and function. The most commonly used are alkaline electrolyzers; a proton exchange membrane (PEM) electrolyzer; and a solid oxide electrolysis cell (SOEC).

An alkaline electrolyzer uses a liquid electrolyte solution, such as potassium hydroxide or sodium hydroxide, and water. Hydrogen is produced in a cell consisting of an anode, a cathode and a membrane. The cells are usually assembled in series to produce more hydrogen and oxygen at the same time. When current is applied to the electrolysis cell stack, hydroxide ions move through the electrolyte from the cathode to the anode of each cell, generating bubbles of hydrogen gas on the cathode side of the electrolyzer and oxygen gas at the anode. They have been in use for more than 100 years and do not require noble metals as a catalyst; however, they are bulky equipment that obtains medium purity hydrogen and are not very flexible in operation.

A PEM electrolyzer uses a proton exchange membrane and a solid polymer electrolyte. When current is applied to the battery, water splits into hydrogen and oxygen and the hydrogen protons pass through the membrane to form hydrogen gas on the cathode side. They are the most popular because they produce high-purity hydrogen and are easy to cool. They are best suited to match the variability of renewable energies, are compact and produce high-purity hydrogen. On the other hand, they are somewhat more expensive because they use precious metals as catalysts.

A SOEC operates at a higher temperature (between 20° and 850° C.) and have the potential to be much more efficient than PEMs and alkaline electrolyzers. The process is called high-temperature electrolysis (HTE) or steam electrolysis and uses a solid ceramic material as the electrolyte. Electrons from the external circuit combine with water at the cathode to form hydrogen gas and negatively charged ions. Oxygen then passes through the sliding ceramic membrane and reacts at the anode to form oxygen gas and generate electrons for the external circuit. Technologically they are less developed than the above. There are other types of electrolyzers that are not yet as efficient or cost-effective as the above but have a lot of potential for development. One example is photo-electrolysis, which uses only sunlight to separate water molecules without the need for electricity.

Thermoelectric power generation plants rarely dispatch 100% of the time during the course of a year. Aside from downtime for maintenance and unscheduled outages, electrical consumption is not uniform during the course of a 24-hour day, nor is it uniform throughout the yearly time period. In general, a thermoelectric power generation plant that dispatched 85% of its total capacity to generate electricity throughout a given year is considered an optimally performing plant, even though the plant may have been available for dispatch 95% of the time. In the end, consumer demand determines the electricity to be supplied by energy distributors, and there will be at all times, during an extended period of time, occasions when the maximum dispatch potential of a plant are not needed. The current system and methods seek to convert into hydrogen the excess heat discharged during the normal operations of a thermoelectric power generation plant, but also to operate the plant at its maximum capacity uniformly, thus allowing operations in base load. Hydrogen production will take place either with the portion of waste heat from standard operations or, even more so, from base load operations, or both. Thermoelectric power plants are often optimized for operations in base load. Frequent variations of the % of base load being generated can lead to equipment performance degradation, increased maintenance costs, and reduction of the life cycle of the plant equipment. Many turbine manufacturers place a yearly limit on the number of times that cold starts may take place before invalidating the equipment warranties. In one embodiment of the present invention, the problem associated with the restrictions on cold starts per year can be avoided by using the portion of the waste heat and the portion of base load production not required by the distribution system during the course of a day, so that the present system and use describes not only a more cost effective means of producing green hydrogen, with its merits for reducing the global warming and its impact on climate change, but it improves the economic yield for thermoelectric power generation plants, increases their operational lifetime, and provides a vital step toward the transition from consuming hydrocarbon fuels to consuming green hydrogen. In essence, it converts a thermoelectric power generation plant into a renewable thermoelectric plant.

As used herein, “liquefied petroleum gas (LPG)” refers to a fuel composed of gases derived from petroleum, which contains a flammable mixture of hydrocarbon gases such as propane, butane, and propylene. When processing petroleum, liquids are first separated from gases. For commercialization, the gases are concentrated into their primary components. The hydrocarbon gas with a high concentration of methane (more than 90%) is called natural gas. The hydrocarbon gas with a high concentration of propane is called petroleum gas. When preparing natural gas or petroleum gas for shipment via ocean going vessels, the gases are treated to undergo a phase transition from its gaseous state to its liquid state pursuant to their relative equation of state that determines the relative pressure and temperature for the transition. Generally, the smaller and less complex the molecule, the greater their molecular binding energy, and the more extreme levels of temperature and pressure required to liquify the gases. Hydrogen corresponds to the smallest and least complex of molecules in existence and thus requires temperatures below 23° K or below −250° C. to maintain its liquid state. LPG containing 95% propane can be maintained in liquid state at temperatures above −50° C. at standard pressures and is readily regasified commercially without the need for a dedicated regassification plant.

As used herein, “fuel gas” or “FUEL” refers to any one of a number of fuels that under ordinary conditions of temperature and pressure are gaseous. Many fuel gases are composed of hydrocarbons such as methane or propane, hydrogen, carbon monoxide, or mixtures thereof. Such gases are sources of potential heat energy or light energy that can be readily transmitted and distributed through pipes from the point of origin directly to the place of consumption. Whenever the FUEL needs shipment over distances where pipelines are not available, then the FUEL needs to be shipped using ocean going vessels where space is at a premium. The FUEL gas is then liquified by a combination of reducing the temperature of the gas and/or increasing the pressure within the gas until the transition from gas to liquid takes place. This is a costly process justified by the cost of ocean transport limited by cargo hold volume. This process is rendered even more costly because the liquified FUEL needs to be regasified at the point of ocean freight delivery before it can be consumed in the power generation plant or other industrial plants.

The global desire to reduce greenhouse gas emissions is a key driver for the widespread use of Liquified Natural Gas (“LNG”) in an effort to replace coal and diesel, and so reduce the emissions of contaminating gases as a byproduct of power generation. It is widely accepted that consuming green hydrogen instead of other hydrocarbon-based FUEL will minimize the emission of contaminants in the generation of electricity. Equipment is available from several manufacturers using hydrogen instead of a hydrocarbon FUEL. The current limitation to the use of hydrogen in the power generation industry, and in many other uses, is first the availability of sufficient volumes of hydrogen at any price and second that the fully amortized cost of generating these volumes of hydrogen be economically competitive when comparing the operational cost (in US$ for example) of the hydrogen per megawatt hour of electrical energy (“MWh”) generated with hydrogen. One established method for generating hydrogen is the electrolysis of water as shown in equations 3 (at the anode) and 4 (at the cathode):

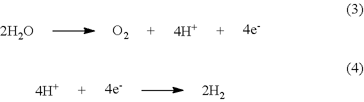

With the overall reaction shown in equation 5:

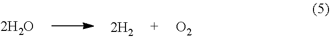

The electrolysis of water is the process of using energy to decompose water into oxygen and hydrogen gas. Hydrogen gas released in this way can be used as a hydrogen fuel source. Electrolysis requires a minimum potential difference of 1.23 volts, though at that voltage external heat is required from the environment. If electrolysis is carried out at high temperature, this voltage reduces. This effectively allows an electrolyzer to operate at near 100% electrical efficiency. In electrochemical systems this means that heat must be supplied to the reactor to sustain the reaction. In this way thermal energy can be used for part of the electrolysis energy requirement.

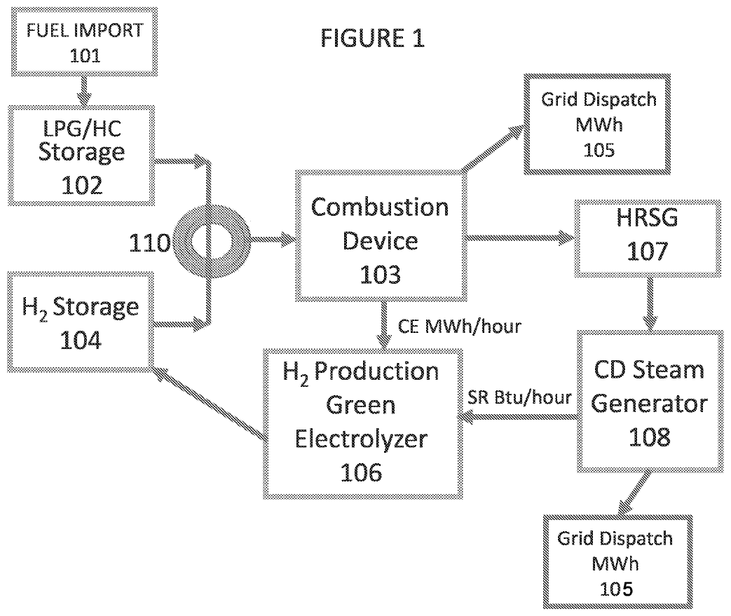

FIG. 1 illustrates an embodiment of a system for generating electricity, while producing green hydrogen through the electrolysis of water, and storing and/or using the generated green hydrogen as a fuel source for further generation of electricity. As shown in this figure, a first round of electricity can be generated at a combustion device, and the excess thermal energy (heat) generated can be used to generate a second round of electricity, where a portion of each round of generated electricity can be used in the electrolysis of water to generate green hydrogen. During the second round of generating electricity, the resulting stack emissions from the first round are recovered in a boiler or heat recovery steam generator (“HRSG”) and the resulting steam is used to power a steam turbine/generator. The combination of both the first and second rounds of power generation results in net conversion of the heat entering the combustion process as FUEL into electric energy and ultimate discarded energy that is exhausted into the environment with the contaminant stream. The amount of energy provided by the FUEL for the combustion process is reported as its Lower or Higher Heating Value (“LHV” or “HHV” respectably). The ratio of electrical energy dispatched to the thermal energy contained in the FUEL required by the power generation plant to generate the electrical energy dispatch is referred to as the net plant efficiency (“NPE”). Considerable efforts have been made to increase NPE over the past century resulting in NPEs today of 60% or more. This means that, even with the most efficient equipment available commercially today, nearly 40% or more of the thermal energy provided by the FUEL exits the power generation process in some form of exhaust heat and is wasted.

Several efforts have been made to profit commercially from this exhaust heat, primarily to provide heated water to consumers for heating homes. This is not an efficient use of the exhaust energy as much of the energy is dissipated during the distribution process.

Hydrogen is the source material whereby stars convert hydrogen to helium and thereby generates light. On our planet Earth, hydrogen molecules are not readily available in nature but is commonly found in many naturally occurring compounds. Water contains an abundant supply of hydrogen. Hydrogen itself is a colorless gas but there are around nine color codes to identify the different types of hydrogen, primarily related to the method and materials used during its production. The color codes of hydrogen refer to the source or the process used to make hydrogen. These codes are green, blue, grey, brown or black, turquoise, purple, pink, red and white. Green hydrogen is produced through water electrolysis process by employing renewable or fuels that do not contain carbon compounds to generate electricity. The reason it is called green is that there is no carbon dioxide emission during the production process. By contrast, white hydrogen refers to naturally occurring hydrogen; black or brown hydrogen, refers to hydrogen produced from coal; and gray hydrogen refers to hydrogen produced from fossil fuels and blue commonly uses steam methane reforming (SMR) for its generation.

As shown in FIG. 1, liquified petroleum gas (LPG) or other hydrocarbon (HC) fuels (collectively “FUEL”) 101 can be imported and/or stored in an LPG/HC storage device 102 such as a tank or a floating “very large gas carrier” (VLGC) anchored in proximity to a combustion device 103. These FUELs are normally imported from a remote source via maritime transport, pumped into and kept at a controlled temperature and pressure in a storage device, and are consumed as needed.

As shown in FIG. 1, green hydrogen can also be stored in gaseous form in a green hydrogen storage device (or tank) 104. In some embodiments, hydrogen can be produced locally and is not intended to be imported from a remote site.

At the start of a combustion cycle, there is ample FUEL in the LPG/HC storage device 102 (such as 50,000 tons of LPG), while the green hydrogen storage device 104 may be essentially empty.

The combustion device initiates operations consuming 100% FUEL and so generates:
1) Electrical energy from the combustion device 103 via a combustion turbine (not shown), which can be dispatched to an electric grid 105 or to a heat recovery steam generator (HRSG) 107 and CD steam generator 108 and subsequently to a hydrogen production green electrolyzer 106;
2) Electrical energy from steam generation via a HRSG 107 and CD steam generator 108, which can be dispatched to an electrical grid 105 or to the hydrogen production green electrolyzer 106; and
3) Thermal energy in the form of steam and exhaust products, where the remaining thermal energy can be used to ensure that the effluents cannot flow back into the production line.

Under normal operations consuming FUEL, the combustion turbine generates a given amount of electricity that is dispatched to an electrical busbar where it can be propagated over an electrical transmission grid system. Sufficient thermal energy must remain in the power plant production line so as to draw all effluents (e.g., CO, CO₂) up an exhaust stack where the effluents are sufficiently dispersed into the environment. The excess thermal energy is to ensure that the effluents cannot flow back into the production line and be so accumulated, or otherwise become a hazard.

By contrast, a combined cycle power plant uses an assembly of heat engines that work in tandem from the same source of heat, converting it into mechanical energy. On land, when used to make electricity, the most common type is called a combined cycle gas turbine (CCGT) plant. The same principle is also used for marine propulsion, where it is called a combined gas and steam (COGAS) plant. Combining the two thermodynamic cycles for generating electricity via the combustion device 103 and the HRSG 107 and CD steam generator 108 improves overall efficiency, which reduces the net cost of the fuel consumed, since no additional fuel is consumed by the HRSG 107 or the CD steam generator 108.

After completing its cycle in the first engine, the working fluid (the exhaust) is still hot enough that a second subsequent heat engine can extract energy from the heat in the exhaust. By generating power from multiple streams of work, the overall efficiency of the system can be increased by 50-60%. That is, from an overall efficiency of say 34% (for a simple cycle), to as much as 64% (for a combined cycle). Heat engines can only use part of the energy from their fuel, so in a non-combined cycle heat engine, the remaining heat (i.e., hot exhaust gas) from combustion is wasted. In a combined cycle heat engine, the remaining heat from the combined operation is also wasted, but in a considerably less amount.

A heat recovery steam generator (HRSG) is an energy recovery heat exchanger that recovers heat from a hot gas stream, such as a combustion turbine or other waste gas stream. It produces steam that can be used in a process (cogeneration) or used to drive a steam turbine (combined cycle).

In a combined cycle power generation plant, the effluents entering the exhaust stack can be diverted to a HRSG 107, where water is added to the stack effluents and super-heated steam is produced. This steam will include all the contaminants produced during the combustion process and, in particular, the greenhouse gases in proportion to the combustion technology being utilized.

The steam emerging from the HRSG 107 can be used to drive a steam turbine (not shown) in the CD steam generator 108. The steam turbine also generates a given amount of electricity that is also dispatched to an electrical busbar where it can be propagated over an electrical grid 105. As for the exhaust stack for the combustion turbine, enough thermal energy must remain in the power plant production line to draw all effluents up an exhaust stack, and the effluents be sufficiently dispersed into the environment.

The purpose of the HRSG and CD steam generator & steam turbine is to provide added electrical power generation without the consumption of added FUEL thereby increasing the overall efficiency of conversion of the FUEL energy into electric energy. Inevitably, removal of the effluents that occurs via the first stack in an open cycle design, must now take place via the second stack in a combined cycle design.

Similar to the bypass system in the first stack that diverts the flow of effluents to the HRSG, a second bypass system is inserted, for example, in the second stack or at any point in the system where it proves advantageous to extract the high temperature steam for production of hydrogen. When consuming FUEL, this bypass device is left open, and the remaining effluents flow up the stack and are dispersed kinetically into the environment.

A portion of the electricity generated by both the combustion device 103 and the CD steam generator 108 can be used by the hydrogen production green electrolyzer 106 for the electricity needed for the electrolysis of water to produce green hydrogen with no side product greenhouse gases, i.e., no carbon dioxide or other greenhouse gases.

The hydrogen generated can be stored in gaseous form until a sufficient amount is accumulated to replace the FUEL being consumed in the combustion turbines. The combustion turbines can alternatively consume gaseous FUEL or gaseous H₂, or some combination thereof, and are commercially available from several manufacturers. In practice, one would install a sufficiently large hydrogen storage facility to supply hydrogen for an extended period, and one would operate with FUEL until the green hydrogen storage tank is filled with green hydrogen.

The amount of time required to initially fill the green hydrogen storage tank, and the amount of FUEL needed to operate while the green hydrogen storage tank is filled with hydrogen will depend on the technologies being used and the frequency that the plant operator considers prudent when switching between FUEL and hydrogen and back again.

As shown in FIG. 1, there is a valve 110 shown between the LPG/HC storage device 102, the green hydrogen storage device 104 and the combustion device 103. This Valve allows the plant operator to determine whenever sufficient hydrogen has been stored and be able to switch between the two storage devices. Operations with FUEL have been described above.

When operating with a combination of FUEL and H₂, operations are conducted as with 100% FUEL.

When operating with 100% H₂, there is no carbon or nitrogen compounds entering the combustion device 103 as part of the fuel. Carbon and nitrogen compounds will enter the combustion path as part of the air intake into the turbines. It should be recognized that the molar concentrations of carbon in air is a very small fraction of the carbon content in a hydrocarbon fuel gas. Correspondingly, the contaminants that form part of the effluents from the combustion process, when consuming 100% H₂, correspond to what normally is found in air and should not be considered a source of contaminants.

Nevertheless, the HRSG 107 serves to capture a portion of the thermal energy that normally would be exhausted via the combustion turbine stack, which then provides steam for a steam device in the CD steam generator 108 in a manner as previously described.

Since no carbon compounds or nitrogen compounds have been introduced via the fuel and are only in the gas path coming from the ambient air, there is likewise no requirement of excess thermal energy to help evacuate effluents with contaminants via a stack since the contaminants that needed evacuation are not present.

When operating with 100% hydrogen fuel, the excess thermal energy required in the combustion turbine is greatly reduced since the concentrations of contaminants in the fuel are very different. The primary reason for continuing to supply steam to the HRSG and to continue to generate electricity via the steam turbine is to maintain the same continuing operation of the power generation equipment. In other words, the only change is the fuel at the source being supplied alternatively from the FUEL storage or from the hydrogen storage.

The combustion flame can vary as fuels are switched, but the combustors, control systems, and balance of plant are commercially available from several packaged equipment suppliers.

Since the composition of the fuel intake changes, so will the outflow change. The principal difference is that when consuming FUEL, there will be contaminants to evacuate. When consuming 100% green hydrogen, there is not an appreciable volume of contaminants as primarily oxygen and water are found among the effluents.

The second bypass system inserted in the second stack as described above, that was left open when consuming FUEL, can now be closed when consuming 100% green H₂. The remaining thermal energy can now be directed back into the hydrogen production device and so reduce the proportional amount of electrical energy required by this device to produce H₂.

As the mix of electrical and thermal energy being supplied to the hydrogen production device is varied, it is not expected that the same volume of hourly production of hydrogen will be maintained. The volume of green hydrogen produced on an hourly basis can be expected to diminish as an increase is made in the % of energy supplied thermally instead of electrically. The variation will depend on the equipment used, the environmental conditions prevalent, and other factors, which can be determined experimentally on site.

When operating with 100% green hydrogen fuel, the same hourly energy content is continued to be inputted into the fuel but a reduced amount of green hydrogen per hour is generated and the amount of hydrogen in storage will gradually decrease over time.

The amount of time T1 that is required to fill the green hydrogen storage device consuming FUEL, and the amount of time T2 during which the hydrogen in storage is depleted, will vary with technologies used and the capacity of the storage devices. During the commissioning process for each installation, T1 and T2 should be determined initially and monitored constantly.

During each time period T2, power generation can be considered as a renewable supply of electricity. During each time period T1, care should be given to the tons of greenhouse gas equivalents being released to the environment per MWh of electrical power generation. By carefully choosing the power generation configurations and technologies so as to maximize the ratio of T2 divided by (T1+T2), a significant contribution of reduction of emissions of greenhouse gases into the environment per MWh of electrical energy dispatch can be accomplished.

Even though the energy mix being supplied to the Hydrogen Production Device can vary, resulting in a decreased rate of hydrogen production as in (22), and this influences the ratio a, the net effect is a reduction of the total cost of producing green hydrogen. This helps render the transition from a hydrocarbon-based economy to a hydrogen-based economy, to the benefit of the environment and a major step in addressing global warming.

It is important to note that in the above T1>0. Therefore, under all circumstances a<1 and the second law of thermodynamics is observed. The environmental efficiency a of the process will depend on the (i) technologies employed, (ii) the choice of FUEL, and (iii) the extent that the Hydrogen Production device can benefit from consuming less electrical energy and more thermal energy that is otherwise wasted in previous methodologies.

In an embodiment, a bypass valve can be introduced at the base of the exhaust stack, similar to what is employed for providing heat from the combustion turbines for a HRSG in a combined cycle configuration. Instead of providing an input of heat and steam to the HRSGs, the purpose of the second referenced bypass valve is to provide all effluent gas and steam flow into a pipeline to input the heat and steam flow directly into the hydrogen production apparatus.

The hydrogen production apparatus uses electrical energy to heat water and provide superheated steam to the water electrolysis process. If the supplied steam were to achieve temperatures above 2,200° C., being the temperature above which the water molecules dissociate, a very small current would suffice to drive the green electrolysis process. There are various articles dealing with the reduction of input electrical power requirements as a function of water temperature. There are commercial products available that use electrical power to convert liquid water to high temperature steam as part of electrolysis.

The use of electrical power to heat water is either eliminated or reduced by providing large volumes of heated steam at temperatures of 300 to 600° C., or more, directly via the by-pass valve and conduit referenced above. The reduction of input electrical power requirement for production of green hydrogen is significant, but the actual numbers are proprietary information of the turbine manufacturers and not authorized for disclosure. A simple calculation based on the energy content of exhaust heat generated by different turbines indicate that in excess of 75% of the required electrical power needed, without taking advantage of the exhaust heat from the thermoelectric power generation configuration, is no longer necessary for green hydrogen production. Since the main cost of green hydrogen production relates to the requirement of electrical energy and the costs associated thereof, an estimated cost reduction of not less than about 75% from current costs would be expected.

Given that the levelized costs of producing green hydrogen range from $35/ton to as much as $54/ton, the estimated green hydrogen production cost can be reduced to a range from $9-12/ton, that makes green hydrogen more competitive with landed, ready-to-use fuel-supply from hydrocarbons.

Whenever the electrical grid connected cost of electricity becomes sufficiently less expensive than the cost of power generation by the disclosed methods and systems, then electricity from the grid can be purchased and used during the initial stage of filling the green hydrogen storage tank and increasing the proportion (electrical vs thermal) energy supplied to the water electrolyzers up to 100% electrical energy supply.

In several countries, the combination of hydroelectric power and otherwise renewable power generation can supply 100% of the national electrical demand being provided by the grid during limited time periods. This occurs seasonally, for example, when hydroelectric power plants are generating at full capacity during rainy seasons. It also may occur whenever the electrical power demand varies over the course of a day due to lessened consumer demand. In some countries this is referred to peak vs off-peak power demand and varies according to a particular country's power consumption habits. In tropical nations such as Panama, peak electrical power demand/consumption extends from 9 am to 5 pm corresponding to office hours for a country with a services-oriented economy.

In Panama, where the country relies for its power generation predominantly on hydroelectric power and other renewables, whenever such electrical dispatch can satisfy the entire national electrical demand, the spot price for electricity drops to $0/MWh of electricity. This occurs on rare occasions during the peak of the rainy seasons where water reservoirs approach spill level capacity.

In Florida, for example, Tampa Electric reports that peak electrical consumption during winter months is 6 am to 10 am and 6 μm to 10 pm while in summer months is noon to 9 μm. In Pennsylvania, peak consumption hours are 5 to 7 pm Monday to Friday. In California it is 4 to 9 μm. In Michigan, an industrialized state, peak hours are 7 am to 11 μm. In New York, from 7 am to 10 pm. More generally, the U.S. Energy Information Agency (“EIA”) provides similar reports on peak electrical consumption hours (see, https://www.eia.gov/todayinenergy/detail.php?id=42915).

Power grid systems are often benefited by inclusion of turbines that can initiate from a cold-start and achieve peak power capacity within a few minutes. These are frequently referred to as aeroderivative turbines in that they trace their product development from the aviation jet turbines. Larger mainframe turbines have a more extensive ramp-up time period and the limited number of times during the course of a year wherein such cold-starts can take place without invalidating manufacturer product warranties can act as a deterrent to the use of mainframe turbines connected to power grid systems wherein the power generation turbines must be turned down for lack of electrical demand or other factors. Power generation turbines intended for use in an intermittent manner are frequently referred to in the industry as “pig shavers”. The disclosed methods and systems show that reliance on pig shavers or on degradation of equipment to switch from standby to full base load is not necessary where, intead of discontinuing power generation, all you need is to switch generated electrical energy dispatch or generated steam from dispatch to the grid and instead to green hydrogen production and its different end users that can produce Biofuels from reforming biological feed stocks consuming hydrogen to produce a large variety of products including, for example, Sustainable Aviation Fuel (“SAF”).

We note that the shipment of liquid products such as SAF can be accomplished, for example, with ultra large bulk carriers at ambient conditions without the risks associated with liquifying and maintaining hydrogen in a liquid state. Therefore, it is readily feasible to create BioFuel Distribution centers that consume green hydrogen locally produced but is difficult to conceive of a hydrogen maritime distribution center wherein ocean going vessels can transport liquid hydrogen.

The disclosed methods and systems provide electricity to a national grid whenever consumption parameters and other factors combine for an electrical dispatch price from the power generator to the grid greater than the proposed inventions price of electrical dispatch, and to alternatively buy form the national grid electricity whenever these factors combine to provide an electrical purchase price from the grid below the cost of producing electricity by the proposed invention. This later event may occur, for example, when an abundance of nuclear power is available over extended periods of time, as has occurred in France and Germany on occasions.

Green hydrogen fuel production has another overwhelming advantage over hydrocarbon fuels. The raw material for hydrocarbon fuels derive from underground deposits that require drilling, mining, long pipelines through at times delicate habitats, expensive liquefaction processes, limited storage capacities, specialized port facilities for loading specialized vessels that can warrant the extremely low temperatures and high pressures to maintain the hydrocarbons in liquid state, expensive maritime transport of the hydrocarbon liquids to their ultimate destinations, expensive storage of the liquified hydrocarbons at the intended destinations, and expensive regasification of the liquified hydrocarbons before they can be used in the power generation processes. Because of the conditions where hydrogen passes from gas to liquid phase, the above expensive procedures are even less economically attractive for hydrogen.

Conveniently, the hydrogen production facility can be situated in proximity of water, a common occurrence on our planet, and in close proximity of the power generation plant or any hydrogen end-user. In such an embodiment, there is no expense for liquifying, storing or transporting hydrogen as required for other hydrocarbon fuels. Water is nearly everywhere available in large volumes. Ocean water can be desalinated and demineralized as normally required for cooling systems for power generation plants. The difference is that the energy from the heated water for cooling, as well as the heated exhaust water from the bypass valve referenced above, are no longer to be vented to the environment but used in the production of green hydrogen.

The environmental advantages of hydrogen fuel consumption instead of hydrocarbons are available from numerous sources. The counter argument to using hydrogen as a fuel is that it is not economically competitive with other hydrocarbons. The disclosed embodiments show how the levelized cost of hydrogen fuel production, and its eventual consumption can be made more competitive than using hydrocarbons. It is expected that the refurbishment of new and existing combustion turbines, now designed to consume 100% green hydrogen instead of hydrocarbons, as described in white papers from several power generation equipment manufacturers, calls for de minimus changes to seals, flame detection and combustors that can even be field installed, can lead to the reduction of the greenhouse gas emissions to levels required to mitigate global warming and the accompanying effects of climate change. Other equipment manufacturers have similar public-domain white papers describing the status of hydrogen for power generation.

Although green hydrogen is intended to be produced via water electrolysis in the disclosed methods and systems, the energy source for producing green hydrogen to initially fill the green hydrogen storage tank may not necessarily be from a renewable energy source that does not emit CO2e in the process.

As used herein, the term “CO2e” or “carbon dioxide equivalent” is used for describing different greenhouse gases in a common unit. For any quantity and type of greenhouse gas, CO2e signifies the amount of CO₂ which would have the equivalent global warming impact.

Once the green hydrogen storage tank is filled, the valve can be used to switch fuel supply into the power generation plant from the hydrocarbon storage tank to the now filled green hydrogen storage tank (the fill level is arbitrary).

If sufficient attention is given to slowly increase the inlet water temperature during start-up so as to minimize the potential damage to the electrolyzer membranes, the electrolyzer electrodes and other components of the electrolyzer, the inlet water temperature can be increased sufficiently so as to maximize the value of K. The proportion of electrolyzer energy consumption during the process of producing hydrogen from water that is provided in the form of heat energy when compared with electrical energy is given by equation 6:

$$K / ( 1 - K ) where 0 < K < 1 . \qquad ( 6 )$$

As used herein, K is defined as the proportion of energy flowing into the water electrolysis process that is provided in the form of thermal energy; and (1−K) is the proportion of the energy flowing into the electrolysis process in the form of electrical energy.

In practice, K˜1 when the inlet water temperature is above 2200° C. where water dissociates naturally, and a significant current to draw H⁺ cations and OH anions towards their respective electrodes. K˜0 when the water electrolysis process relies almost entirely on electrical current.

During a time-interval equivalent to Tᵢ, the power generation plant depletes a volume D of hydrogen from the green hydrogen storage tank and refills a volume R=V_{T}/Tᵢ.

As used herein, D is the volume of green hydrogen from the green hydrogen storage tank being depleted during a time interval Tᵢ.

As used herein, R is the volume of green hydrogen being refilled into the green hydrogen storage tank after being depleted during time interval Tᵢ.

As used herein, V_{T} is the volume of the green hydrogen tank storage device.

As used herein, Tᵢ is the time (measured in seconds or any other unit for measuring a time interval) required to initially fill the green hydrogen storage tank with hydrogen (V_{T}), while the power generation plant is consuming hydrocarbon fuel such as LPG.

Fis defined as the energy conversion efficiency, whereby the green hydrolysis cell converts the energy E into the caloric content of the hydrogen produced. Examples of PEM, and other green technologies indicate that F ranges from 85% to 99%.

E is defined as the total energy per second flowing into the electrolysis system to maintain green hydrogen production. To optimize the performance of the electrolyzer, it is recommended to minimize the fluctuations in the inlet water temperature flowing into the electrolyzer.

If the time interval Tᵢ of each stage of operation is kept constant (not required, but it simplifies the present calculation), then during each stage there is a decrease of hydrogen in storage equivalent to R−D, where V_{D} is defined as being equal to (R−D)/D.

The amount of hydrogen in the storage tank at the end of stage M, denoted as V_{M}, is given by equation 7 and 8:

$${V}_{M} = {V}_{T} ( 1 + {V}_{D} + {V}_{D}^{2} + {V}_{D}^{3} + … + {V}_{D}^{M} ) , {V}_{D} < 1 \qquad ( 7 )$$

$${V}_{M} = {V}_{T} / ( 1 - {V}_{D} ) + truncation errors of the order of {V}_{D}^{M + 1} \qquad ( 8 )$$

Correspondingly, the ratio of time passed operating as a non-greenhouse gas emission plant consuming hydrogen fuel while producing a combination of green electricity and added green hydrogen when divided by the time required to initially fill the hydrogen storage tank while consuming a hydrocarbon fuel is given approximately by equation 9:

$$1 / ( 1 - {V}_{D} ) \qquad ( 9 )$$

If all of the hydrogen fuel being consumed by the power generation plant is provided by the electrolysis plant being supplied by the recoverable waste heat from the power generation plant (which currently exceeds roughly more than 40% of total energy entering the power generation plant), then the total cost of fuel while consuming this hydrogen is limited to the cost of fuel when initially filling the green hydrogen storage tank, the cost of amortizing the electrolysis unit, the personnel cost during operations, and other variable operational costs. The great majority of the sum of these costs is the cost of the fuel while filing the green hydrogen storage tank.

For a given initial fuel cost C_{H}, required to fill the hydrogen storage tank entirely from electricity (although in another embodiment the waste heat can also be used during this initial phase) provided by the power generation plant, then the weighted average cost of fuel during the initial+M stages of hydrogen production plus the electricity dispatched to the grid is given by equation 10:

$${C}_{H} \times ( 1 - {V}_{D} ) \qquad ( 10 )$$

Whenever (1−V_{D})˜(1-86%), then the resulting cost of fuel averaged over the initial+M stages of production reduces to 14% of C_{H}. Whenever (1−V_{D}) is approximately (1-60%), the average cost of fuel reduces to 40% of C_{H}. In any case, the average cost of fuel <C> is less appreciably than C_{H}.

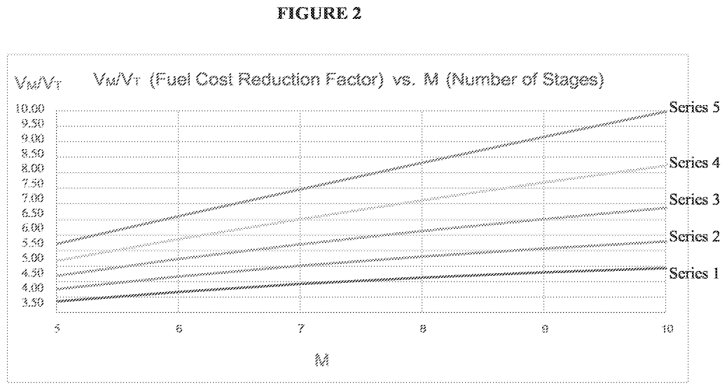

FIG. 2 illustrates how V_{M}/V_{T} (fuel cost reduction factor) varies for M (number stages)=5, 6, 7, 8, 9, 10 for different values of electrolyzer efficiency, where Series Number corresponds to electrolyzer efficiencies of 82%, 86%, 90%, 94%, 98% respectively.

The methods and apparatus for electrolyzer efficiencies are described in numerous publications. The importance of this chart is to show how the present disclosed methods and systems can reduce the average cost fuel as a function of the number of stages M where the thermoelectric power generation plant operates with an initial stage is fueled by a hydrocarbon with cost C_{T} and the Average Fuel Cost (“AFC”) is reduced by a factor of V_{M}/V_{T}.

For PEM electrolyzer with 86% conversion efficiency (Series 2), we see from the chart that for M=7, i.e., a first stage consuming a hydrocarbon with cost CT followed by 7 stages of hydrogen production consuming hydrogen as fuel, the effective AFC is reduced by a factor of 5. For SOEC electrolyzer a greater factor of effective AFC can be achieved in proportion to the reduced electrical consumption.

Accordingly, if the landed, on-site, fully loaded hydrocarbon cost is $1.50/ga, then the effective cost of fuel with the present invention after 7 stages of hydrogen production fueled by self-generated hydrogen fuel is $0.30/ga. Likewise, if the levelized cost of generating hydrogen with K=0 (using solely electrical energy to drive the process of green hydrogen production) is 10 ¢/kg of hydrogen produced, then the effective cost is reduced to 2 ¢/kg. Several published articles indicate that at the effective production levelized cost of 2 ¢/kg, this process produces green hydrogen less expensively that other methods using hydrocarbons and even for configurations based on “renewable” power generation, where renewable is limited to eolic and photovoltaic power generation.

Whenever “renewable” refers to power generation wherein zero tons of CO2e emissions are vented to ambient, then the above-described power generation process can be considered as renewable power generation during the 7 stages where green hydrogen is produced from hydrogen fuel. To illustrate, if it requires one week to initially fill the hydrogen storage tank consuming a hydrocarbon followed by seven weeks generating electricity and added hydrogen fuel while consuming hydrogen fuel, then during the course of one year, the above configuration will supply power based on hydrocarbons during approximately 6.5 weeks and will supply green power based on renewable power generation consuming 100% hydrogen during approximately 45.5 weeks of the year.

The total greenhouse gas emissions for this example during the course of the year will be reduced to 6.5/52 or an emissions reduction of 87.5% from emissions levels with conventional state-of-the-art thermoelectric power generation plants today. Such an emissions reduction applied generally to the thermoelectric power generation industry, coupled with the widespread use of electrical or hydrogen fueled or biofueled vehicles in the transportation industry, can be expected to sufficiently reduce greenhouse gas emissions worldwide so as to halt global warming within 5 years of implementation of a shift in the industry to a system of power generation as described herein.

While the inventive natures have been particularly shown and described with reference to preferred embodiments thereof, it will be understood by those in the art that the foregoing and other changes can be made therein without departing from the spirit and the scope of the disclosure. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the disclosure should not be limited by any of the above-described exemplary embodiments.

What is claimed is:

1. A method of generating electricity, comprising:
generating a first round of electricity from a hydrocarbon fuel source;
dispatching the first round of electricity to an electric grid and/or a hydrogen production green electrolyzer;
recovering steam from the generation of the first round of electricity;
generating a second round of electricity from the recovered steam;
dispatching the second round of electricity to the electric grid and/or the hydrogen production green electrolyzer, wherein dispatch to the electrolyzer includes both electrical and thermal energy;
generating green hydrogen through electrolysis of water at the hydrogen production green electrolyzer; and
storing and/or using the generated green hydrogen as a fuel source for generating the first round of electricity.

2. The method of claim 1, wherein the hydrocarbon fuel source is liquefied petroleum gas (LPG) or liquified natural gas (LNG).

3. The method of claim 1, wherein generating the first round of electricity comprises combusting the hydrocarbon fuel source in a combustion device.

4. The method of claim 3, wherein recovering steam from generating the first round of electricity comprises dispatching stack emissions and heat generated from the combustion device to a heat recovery steam generator.

5. The method of claim 4, wherein generating the second round of electricity from the recovered steam comprises dispatching the recovered steam from the heat recovery steam generator to a steam turbine generator.

6. The method of claim 1, further comprising:
storing the hydrocarbon fuel source in a hydrocarbon fuel storage tank; and
storing the generated green hydrogen in a green hydrogen storage tank.

7. The method of claim 6, further comprising regulating the fuel source between the stored hydrocarbon fuel storage tank and the generated green hydrogen storage tank using a valve.

8. The method of claim 1, wherein the hydrogen production green electrolyzer is an alkaline electrolyzer, a proton exchange membrane (PEM) electrolyzer, or a solid oxide electrolysis cell (SOEC).

9. The method of claim 1, wherein electricity from the electric grid can be dispatched to the hydrogen production green electrolyzer when the cost of purchasing electricity from the electric grid is less than generating the first round of electricity from the hydrocarbon fuel source and/or generating the second round of electricity from the recovered steam.

10. A system for generating electricity, comprising:
a hydrocarbon fuel storage tank for storing a hydrocarbon fuel source;
a combustion device for generating a first round of electricity from the hydrocarbon fuel source;
a grid for dispatching the first round of electricity;
a heat recovery steam generator for recovering steam from the combustion device after the generation of the first round of electricity;
a steam turbine generator for generating a second round of electricity from the recovered steam;
a green hydrogen electrolyzer for generating green hydrogen from the electrolysis of water using electricity generated from the combustion device and electrical and thermal energy generated from the steam turbine generator; and
a green hydrogen storage tank for storing the generated green hydrogen.

11. The system of claim 10, wherein the hydrocarbon fuel source is liquefied petroleum gas (LPG) or liquified natural gas (LNG).

12. The system of claim 10, wherein the combustion device combusts the hydrocarbon fuel source.

13. The system of claim 10, wherein the heat recovery steam generator recovers steam from stack emissions and heat generated from the combustion device.

14. The system of claim 10, further comprising a valve for regulating the fuel source between the stored hydrocarbon fuel storage tank and the generated green hydrogen storage tank.

15. The system of claim 1, wherein the hydrogen production green electrolyzer is an alkaline electrolyzer, a proton exchange membrane (PEM) electrolyzer, or a solid oxide electrolysis cell (SOEC).

16. A method of reducing the cost of producing green hydrogen, comprising: generating electricity from a hydrocarbon fuel source; dispatching the electricity to an electric grid and a hydrogen production green electrolyzer, wherein dispatch to the electrolyzer includes both electrical and thermal energy; generating green hydrogen through electrolysis of water at the hydrogen production green electrolyzer; and storing and/or using the generated green hydrogen as a fuel source for generating electricity.

17. The method of claim 16, further comprising: recovering steam from the generation of electricity; generating additional electricity from the recovered steam; dispatching the additional electricity to the electric grid and the hydrogen production green electrolyzer, wherein dispatch to the electrolyzer includes both electrical and thermal energy.

18. The method of claim 17, wherein recovering steam from the generation of electricity comprises dispatching stack emissions and heat generated from the combustion device to a heat recovery steam generator.

19. The method of claim 17, wherein the generation of the additional electricity from the recovered steam comprises dispatching the recovered steam from the heat recovery steam generator to a steam turbine generator.

20. The method of claim 16, wherein the hydrocarbon fuel source is liquefied petroleum gas (LPG) or liquified natural gas (LNG).

21. The method of claim 16, further comprising regulating the fuel source between the stored hydrocarbon fuel storage tank and the generated green hydrogen storage tank using a valve.

22. The method of claim 16, wherein the hydrogen production green electrolyzer is an alkaline electrolyzer, a proton exchange membrane (PEM) electrolyzer, or a solid oxide electrolysis cell (SOEC).

23. The method of claim 16, wherein electricity from the electric grid can be dispatched to the hydrogen production green electrolyzer when the cost of purchasing electricity from the electric grid is less than generating electricity from the hydrocarbon fuel source.

24. The method of claim 17, wherein electricity from the electric grid can be dispatched to the hydrogen production green electrolyzer when the cost of purchasing electricity from the electric grid is less than generating the additional electricity from the recovered steam.
